(19) United States
(12) Patent Application Publication
(10) Pub. No.: US 2015/0336509 A1
(43) Pub. Date: Nov. 26, 2015

(54) Vehicle Light Monitoring System

(71) Applicants: Harold Davis, Twentynine Palms, CA (US); Deborah Davis, Twentynine Palms, CA (US)

(72) Inventors: Harold Davis, Twentynine Palms, CA (US); Deborah Davis, Twentynine Palms, CA (US)

(21) Appl. No.: 14/717,365

(22) Filed: May 20, 2015

Related U.S. Application Data
(60) Provisional application No. 62/000,912, filed on May 20, 2014.

(51) Int. Cl. B60Q 11/00

(52) U.S. Cl. CPC B60Q 11/005

(57) ABSTRACT

A vehicle light monitoring system for allowing a user to determine if a vehicle's headlights and taillights are functioning properly. The vehicle light monitoring system includes a console mountable within the interior of the vehicle, wherein the console includes a representation of a vehicle thereon that shows the vehicle's headlights and taillights. The system further includes fiber optic cables each having a first end and a second end, wherein the cables are positioned such that the first end of the cable is adjacent to a headlight or taillight of the vehicle, and the second end is secured to the console and is arranged so that it is disposed on the headlight or taillight portion of the vehicle representation. Thus, when a vehicle's headlights or taillights are illuminated, the end of the fiber optic cable on the console will also be illuminated.

### CROSS REFERENCE TO RELATED APPLICATION

This application claims the benefit of U.S. Provisional Application No. 62/000,912 filed on May 20, 2014. The above identified patent application is herein incorporated by reference in its entirety to provide continuity of disclosure.

### BACKGROUND OF THE INVENTION

### Field of the Invention

The present invention relates to vehicle light monitoring systems. More specifically, the present invention provides a vehicle light monitoring system for allowing the user to determine if the headlights and taillights of a vehicle are functioning properly. The vehicle light monitoring system comprises a console mountable within the interior of a vehicle, wherein the console displays a representation of the vehicle and its headlights and taillights. A plurality of fiber optic cables each including a first end and a second end, wherein the first end is positioned adjacent to a headlight or taillight of the vehicle, and the second end is secured to the console in the location of the corresponding headlight or taillight on the representation of the vehicle.

Vehicle headlights and taillights can fail to function properly for any of various reasons. The headlight or taillight may be damaged in an accident causing it to fail to illuminate. The bulb of the headlight or taillight can burn out after extended use. Alternatively, the headlight or taillight fixture or socket can become worn or corroded after extended use. In any case, failure to have functioning headlights or taillights can be dangerous for the driver and for others on the road. Further, failure to have properly functioning vehicle lights is a traffic violation and the driver may be fined for failure to maintain the lights of the vehicle in a working condition.

However, it can be difficult for the driver of the vehicle to determine if his or her headlights and taillights are working properly. The user often requires the assistance of another person in order to check the lights while the user adjusts the light controls and actuates the brakes within the vehicle. This is particularly true for taillights, as the user cannot easily determine whether the taillights are working while the user is driving the vehicle. Thus, a device for allowing a user to determine whether the vehicle lights are functioning properly is desired.

Devices have been disclosed in the prior art that relate to vehicle light inspection systems. These include devices that have been patented and published in patent application publications. Such devices generally relate to systems for checking the operation of exterior vehicle lights, including U.S. Pat. No. 3,588,816, U.S. Pat. No. 7,430,464, and U.S. Pat. No. 7,132,935. Other patents and publications relate to systems for controlling operation of vehicle lights and other features, such as U.S. Pat. No. 4,139,801, U.S. Pat. No. 6,674,288, and U.S. Published Patent Application Number 2014/0036080.

These prior art devices have several known drawbacks. The devices in the prior art fail to provide a vehicle light monitoring system that comprises a console that displays a visual representation of a vehicle that shows the vehicle headlights and taillights. Such devices further fail to disclose the use of fiber optic cables for transmitting light produced by the headlights or taillights to a console on the interior of the vehicle so that the user can easily determine if his or her vehicle's headlights or taillights are functioning properly.

In light of the devices disclosed in the prior art, it is submitted that the present invention substantially diverges in design elements from the prior art and consequently it is clear that there is a need in the art for an improvement to existing vehicle light monitoring devices. In this regard the instant invention substantially fulfills these needs.

### SUMMARY OF THE INVENTION

In view of the foregoing disadvantages inherent in the known types of vehicle light monitoring systems now present in the prior art, the present invention provides a new vehicle light monitoring system wherein the same can be utilized for providing convenience for the user when determining if a vehicle's headlights and taillights are functioning properly.

It is therefore an object of the present invention to provide a new and improved vehicle light monitoring system comprising a console mountable within the interior of a vehicle, wherein the console displays a representation of the vehicle which shows the vehicle's headlights and taillights, wherein the headlights and taillights on the representation are illuminated when the corresponding vehicle headlights and taillights are illuminated.

It is another object of the present invention to provide a vehicle light monitoring system comprising a plurality of fiber optic cables arranged such that a first end of said fiber optic cable is adjacent to a headlight or taillight of a vehicle, and wherein a second end is secured to a console within the user's vehicle.

Another object of the present invention is to provide a vehicle light monitoring system comprising a plurality of fiber optic cables that transmit light from a vehicle headlight or taillight to a console on the interior of a vehicle so as to allow a user to easily determine if his or her headlights and taillights are functioning properly.

Yet another object of the present invention is to provide a vehicle light monitoring system that allows a user to determine if a vehicle's headlights and taillights are illuminated while inside of the vehicle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic view of the vehicle light monitoring system of the present invention.

FIG. 2 shows an embodiment of the console of the vehicle light monitoring system.

### DETAILED DESCRIPTION OF THE INVENTION

Reference is made herein to the attached drawings. Like reference numerals are used throughout the drawings to depict like or similar elements of the vehicle light monitoring system. For the purposes of presenting a brief and clear description of the present invention, the preferred embodiment will be discussed as used for allowing a user to determine if a vehicle's headlights and taillights are functioning properly from within the vehicle. The figures are intended for representative purposes only and should not be considered to be limiting in any respect.

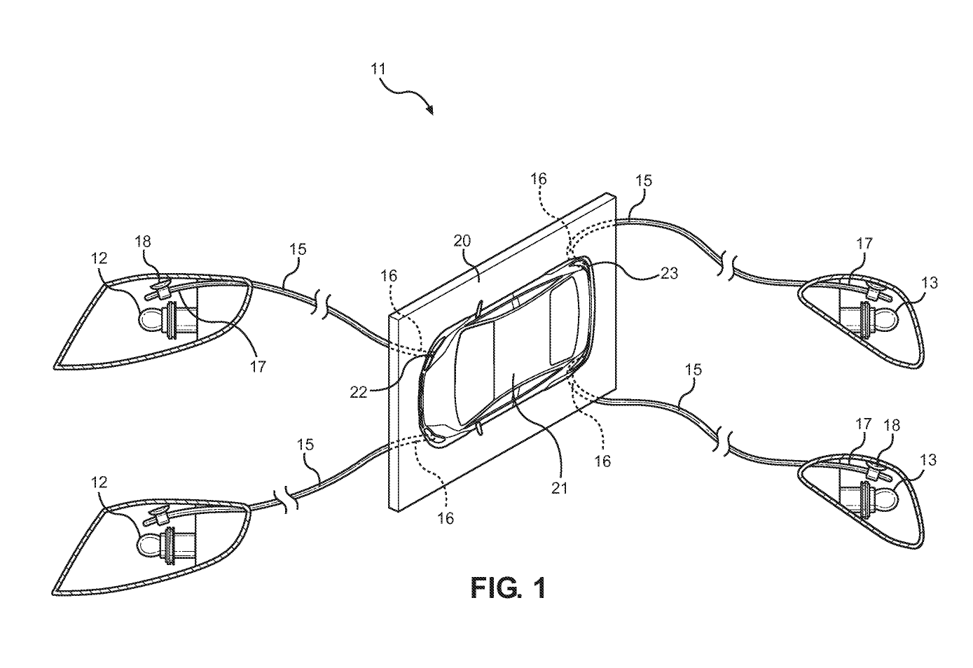

Referring now to FIG. 1, there is shown a schematic view of the vehicle light monitoring system of the present invention. The vehicle light monitoring system 11 comprises a console 20 adapted to be mounted within the interior of a vehicle. The console 20 is shown as having a rectangular configuration, wherein the front surface of the console 20 is substantially flat or planar. The console 20 can be mounted on a vehicle dashboard using any suitable fasteners such as brackets, suction cups, or adhesives, among others. In some embodiments, the console 20 is permanently installed within the vehicle's dashboard.

The console 20 displays a representation 21 of a vehicle thereon. The representation 21 may be a drawing or a photographic image of the vehicle. The representation 21 is preferably a top down image of a vehicle, wherein the representation 21 includes a pair of headlights 22 and a pair of taillights 23. The representation's headlights 22 and taillights 23 are adapted to illuminate when the corresponding headlights and taillights on the vehicle are illuminated. In this way, the user can easily determine if his or her vehicle's headlights and taillights are illuminated, without having to leave the vehicle or request the assistance of another person. Further, the user can easily determine which headlight or taillight is not functioning based upon the vehicle representation 21. For example, if the passenger side headlight is not functioning, the representation's passenger side headlight will not be illuminated on the console 20.

The vehicle light monitoring system 11 further comprises a plurality of fiber optic cables 15 having a first end 16 and a second end 17, wherein each fiber optic cable 15 is adapted to transmit light therethrough. The first end 17 of each fiber optic cable 15 is disposed adjacent to a vehicle's headlight 12 or taillight 13. The fiber optic cable 15 can be secured in a desired position using any of various suitable fasteners 18. In the illustrated embodiment, a suction cup is affixed to the first end 17 of the fiber optic cable 15 wherein the suction cup can be affixed to the housing of the headlight 12 or taillight 13. In other embodiments, the first end 17 of the fiber optic cable is secured via alternate types of fasteners, and may be permanently affixed adjacent to the headlight 12 or taillight 13. In this way, when the vehicle headlight 12 or taillight 13 is illuminated, light produced thereby will enter the fiber optic cable 15 through the first end 17 and the light will be transmitted through the cable 15 towards the second end 16 thereof. The second end 16 of each fiber optic cables 15 is secured to the console 20 so as to transmit light produced from the vehicle headlights and taillights to the console, and thereby notifying a user if each vehicle light is functioning properly.

The fiber optic cables 15 can be arranged within the vehicle so that the fiber optic cables 15 extend along with the vehicle's electrical wiring. In this way, the fiber optic cables 15 can be easily integrated into the vehicle without the need for substantial alterations to the vehicle's design or wiring. Further, the fiber optic cables 15 do not require a power source and thus are not connected to the vehicle's electrical or lighting systems.

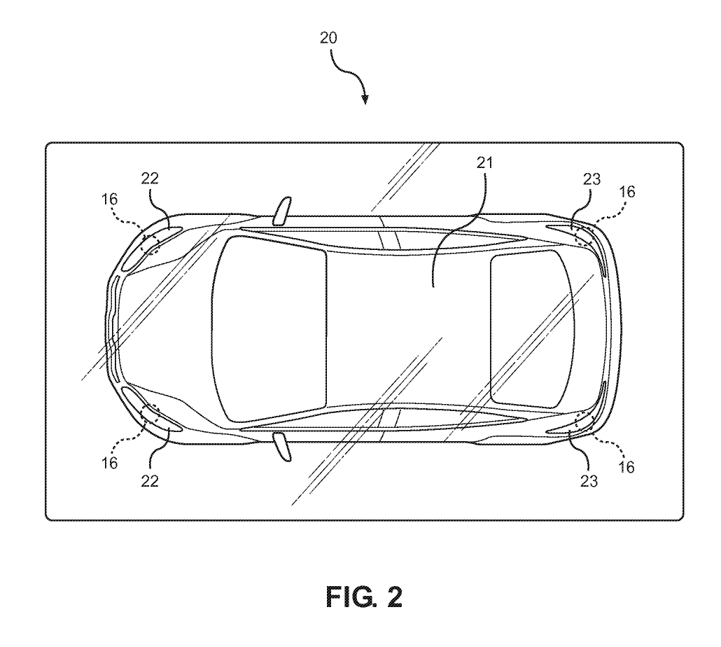

Referring now to FIG. 2, there is shown an embodiment of the console of the vehicle light monitoring system. The second end 16 of each fiber optic cable 15 is attached to the console 20. Each fiber optic cable 15 corresponds to a particular vehicle light, such as the driver side headlight or the passenger side headlight. For example, one fiber optic cable 15 has a first end adjacent to the driver side headlight and the second end of that fiber optic cable 15 is disposed on the console 20 in the location of the driver side headlight 22 of the representation 21 of the vehicle displayed on the console 20. In this way, the console displays a representation 21 of a vehicle wherein the headlights 22 and taillights 23 on the console 20 correspond to the vehicle's headlights and taillights. If the vehicle headlight or taillight is illuminated, light will be transmitted through the corresponding fiber optic cable 15 to the visual representation 21 so as to notify the user the working state of the headlights and taillights. However, if a vehicle headlight or taillight is not illuminated, then no light is transmitted through the cable 15, and the headlight 22 or taillight 23 on the representation 21 of the vehicle will not be illuminated.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicle light monitoring system, comprising:
a console having a representation of a vehicle therein, wherein said representation includes a pair of headlights and a pair of taillights;
a plurality of fiber optic cables each having a first end and a second end;
said first end of said plurality of fiber optic cables adapted to be positioned adjacent to a headlight or a taillight of a vehicle;
said second end of said plurality of fiber optic cables secured to said console, wherein a light produced by said headlight or said taillight is adapted to travel through said plurality of fiber optic cables to said console.

2. The vehicle light monitoring system of claim 1, wherein said console comprises a rectangular panel.

3. The vehicle light monitoring system of claim 1, wherein said second end of said plurality of fiber optic cables are secured to one of said pair of headlights or one of said pair of taillights of said representation on said console.

4. The vehicle light monitoring system of claim 1, wherein each of said plurality of fiber optic cables corresponds to said headlight or said taillight of a vehicle.

5. The vehicle light monitoring system of claim 4, wherein said pair of headlights and said pair of taillights on said representation on said console correspond to said headlights and said taillights of said vehicle.

6. The vehicle light monitoring system of claim 1, wherein said console is adapted to be mounted within a vehicle.

7. The vehicle light monitoring system of claim 1, wherein said plurality of fiber optic cables include a fastener on said first end thereof for securing said plurality of fiber optic cables in a desired position adjacent to said headlight or said taillight of said vehicle.
